(19) United States
(12) Patent Application Publication
(10) Pub. No.: US 2014/0026003 A1
(43) Pub. Date: Jan. 23, 2014

(54) FLASH MEMORY READ ERROR RATE REDUCTION

(71) Applicants: Zhengang Chen, San Jose, CA (US); Yunxiang Wu, Cupertino, CA (US)

(72) Inventors: Zhengang Chen, San Jose, CA (US); Yunxiang Wu, Cupertino, CA (US)

(21) Appl. No.: 13/555,444

(22) Filed: Jul. 23, 2012

(51) Int. Cl. G06F 11/07

(52) U.S. Cl. 714/708; 714/E11.023

(57) ABSTRACT

An apparatus having a first circuit and a second circuit is disclosed. The first circuit may be configured to (i) generate a reference voltage used by a memory circuit in a first read of a set of data and (ii) adjust the reference voltage based on a plurality of parameters to lower an error rate in a second read of the set from the memory circuit. The second circuit may be configured to update the parameters in response to an error correction applied to the set after the first read from the memory circuit. The memory circuit is generally configured to store the data in a nonvolatile condition by adjusting a plurality of threshold voltages.

### FIELD OF THE INVENTION

The present invention relates to nonvolatile memories generally and, more particularly, to a method and/or apparatus for implementing a flash memory read error rate reduction.

### BACKGROUND OF THE INVENTION

Data is conventionally stored in flash memory in a digital format (i.e., stored as bits). However, an underlying physical media in each memory cell typically exhibits the data as a level of a threshold voltage, which is an analog signal. The threshold voltage is achieved by storing a certain amount of electric charge in a floating gate. The bits are read out by applying a reference voltage to control gates of the memory cells. The bits are sensed by determining whether transistors in the memory cells are switched on or off by the applied reference voltage. Although the threshold voltages fluctuate with many noise factors, such as program/erase cycling, retention and read/write disturbances, if the threshold voltages do not cross a boundary defined by the reference voltage, the stored bits can be correctly read out of the memory. Read error rates increase when the threshold voltages cross the boundary.

It would be desirable to implement a flash memory read error rate reduction.

### SUMMARY OF THE INVENTION

The present invention concerns an apparatus having a first circuit and a second circuit. The first circuit may be configured to (i) generate a reference voltage used by a memory circuit in a first read of a set of data and (ii) adjust the reference voltage based on a plurality of parameters to lower an error rate in a second read of the set from the memory circuit. The second circuit may be configured to update the parameters in response to an error correction applied to the set after the first read from the memory circuit. The memory circuit is generally configured to store the data in a nonvolatile condition by adjusting a plurality of threshold voltages.

The objects, features and advantages of the present invention include providing a method and/or apparatus for implementing a flash memory read error rate reduction that may (i) reduce read error rates, (ii) track channel parameters for multiple data groups, (iii) track the channel parameters without performing extra reads, (iv) operate with flash memory, (v) operate with solid state drives, (vi) adjust a reference voltage used by a memory to read data, (vii) adjust soft-decision decoding to account for channel parameter drifting, (viii) operate with different data group granularity and/or (ix) be implemented in an integrated circuit.

### BRIEF DESCRIPTION OF THE DRAWINGS

These and other objects, features and advantages of the present invention will be apparent from the following detailed description and the appended claims and drawings in which:

FIG. 1 is a block diagram of an example apparatus;

FIG. 2 is a block diagram of an example implementation of a controller in the apparatus in accordance with a preferred embodiment of the present invention;

FIG. 3 is a graph of example single-level cell threshold voltage distributions;

FIG. 4 is a graph of shifted single-level cell threshold voltage distributions;

FIG. 5 is a graph of example multi-level cell threshold voltage distributions; and

FIG. 6 is a block diagram of an example implementation of a tracking circuit.

### DETAILED DESCRIPTION OF THE PREFERRED EMBODIMENTS

Due to program/erase cycling, retention, read disturb and other factors, channel characteristics of nonvolatile (e.g., flash) memory may change over time. Multiple parameters that generally represent the channel characteristics in a flash device and/or a solid state drive may be tracked. The tracking generally enables the parameters to be tuned in a timely manner to improve a system performance. Some embodiments of the present invention generally track the parameters based on hard-decision reads. The tracking may be done “online” in the sense that only normal hard-decision reads with successful decoding may be relied upon and no additional reads may be performed for the sake of the tracking (e.g., “offline” reads).

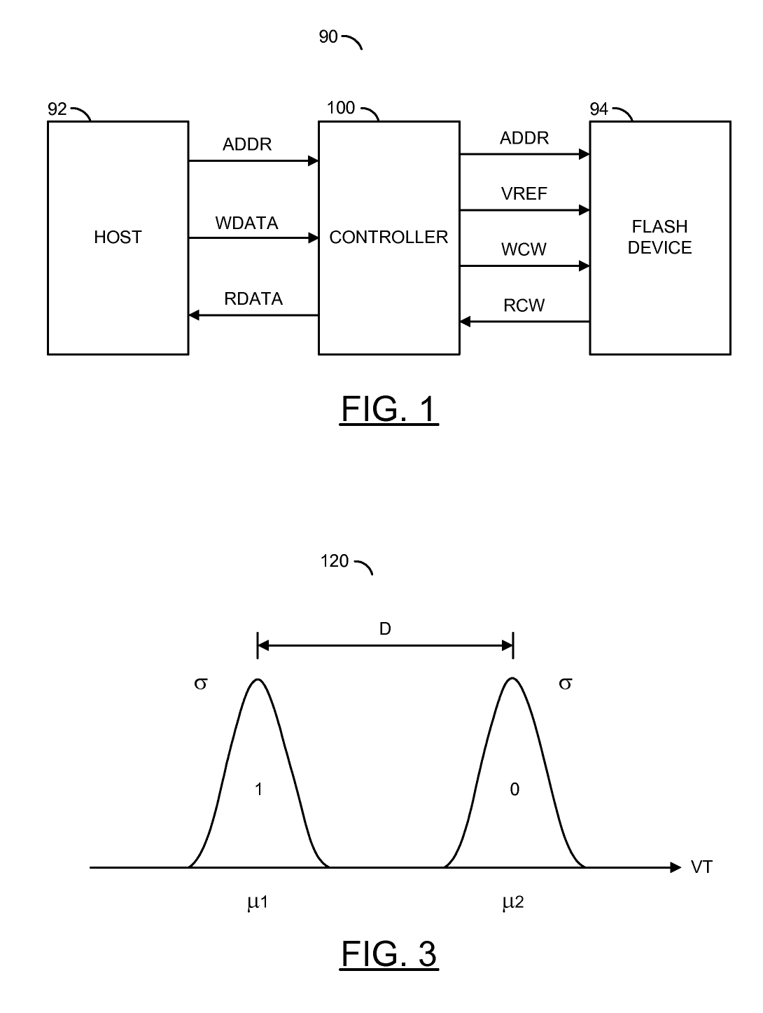

Referring to FIG. 1, a block diagram of an example apparatus 90 is shown. The apparatus (or circuit or device or integrated circuit) 90 may implement a computer having a nonvolatile memory circuit. The apparatus 90 generally comprises a block (or circuit) 92, a block (or circuit) 94 and a block (or circuit) 100. The circuits 92 to 100 may represent modules and/or blocks that may be implemented as hardware, software, a combination of hardware and software, or other implementations.

A signal (e.g., ADDR) may be generated by the circuit 92 and received by the circuits 94 and 100. The signal ADDR may implement an address signal used to access data in the circuit 94. A signal (e.g., VREF) may be generated by the circuit 100 and presented to the circuit 94. The signal VREF may convey a reference voltage used by the circuit 94 to read data. A signal WDATA may be generated by the circuit 92 and presented to the circuit 100. The signal WDATA generally conveys write data to be written into the circuit 100. A signal (e.g., WCW) may be generated by the circuit 100 and transferred to the circuit 94. The signal WCW may carry error correction coded (e.g., ECC) write codewords that are written into the circuit 94. A signal (e.g., RCW) may be generated by the circuit 94 and received by the circuit 100. The signal RCW may carry ECC codewords read from the circuit 94. A signal (e.g., RDATA) may be generated by the circuit 100 and presented to the circuit 92. The signal RDATA may carry error corrected versions of the data in the signal RCW.

The circuit 92 may implement a host circuit. The circuit 92 is generally operational to read and write data to and from the circuit 94. When reading or writing, the circuit 92 may place an address value in the signal ADDR to identify which set of data is to be written to or read from the circuit 94. The write data may be presented in the signal WDATA The read data requested by the circuit 92 may be received via the signal RDATA.

The circuit 94 may implement a nonvolatile memory circuit. In some embodiments, the circuit 94 may be a flash device. In other embodiments, the circuit 94 may be implemented as a solid state drive having many flash devices. The circuit 94 is generally operational to store data in a nonvolatile condition. When data is read from the circuit 94, the circuit 94 may access a set of data (e.g., multiple bits) identified in the signal ADDR. A threshold voltage of each memory cell within the accessed set may be compared to the reference voltage in the signal VREF. For each memory cell where the reference voltage is above the threshold voltage, one or more logical values may be sensed. For each memory cell where the reference voltage is below the threshold voltage, one or more different logical values may be sensed.

In some embodiments, the circuit 94 may be implemented as a single-level cell (e.g., SLC) type circuit. A SLC type circuit generally stores a single bit per memory cell (e.g., a logical 0 or 1). In other embodiments, the circuit 94 may be implemented as a multi-level cell (e.g., MLC) type circuit. An MLC type circuit is generally capable of storing multiple (e.g., two) bits per memory cell (e.g., logical 00, 01, 10 or 11). In still other embodiments, the circuit 94 may implement a triple-level cell (e.g., TLC) type circuit. A TLC circuit may be able to store multiple (e.g., three) bits per memory cell (e.g., a logical 000, 001, 010, 011, 100, 101, 110 or 111).

The signal ADDR generally spans an address range of the circuit 94. The address range may be divided into multiple groups. Each group may be divided into one or more sets of data. Each set of data generally incorporates multiple memory cells. The signal WCW may write an entire set (or ECC codeword) into the circuit 94. The signal RCW may read an entire set (or ECC codeword) from the circuit 94.

The circuit 100 may implement a controller circuit. The circuit 100 is generally operational to control reading to and writing from the circuit 94. The circuit 100 may be implemented as one or more integrated circuits (or chips or die).

As part of a read access to the circuit 94, the circuit 100 may generate the reference voltage in the signal VREF. The reference voltage may be adjusted based on channel parameters (or read parameters or flash channel parameters) of the circuit 94 to minimize a read error rate. Adjustments of the channel parameters may be performed based on each “online” read. An online read generally means that the read takes place because the circuit 92 has requested the read data and/or the circuit 100 is performing maintenance on the circuit 94. An “offline” read may be considered a read used only to measure and/or update the channel parameters (e.g., no data is presented to the circuit 92).

The circuit 100 may also include an error correction coding (e.g., ECC) capability and an error detection and correction (e.g., EDC) capability. The error correction coding may be used to add additional bits to sets of data received in the signal WDATA. The extra bits generally enable the detection and ultimate correction of one or more bits that may become corrupted between a write and one or more subsequent reads. The ECC data (e.g., the original data plus the extra bits) may be presented in the signal WCW.

The error detection and correction capability may provide an ability to detect when one or more bits in the signal RCW have been corrupted (e.g., flipped). The error detection and correction capability may also correct a limited number of the corrupted bits. The corrected data may be presented in the signal RDATA. The error detection and correction feature may also generate statistics concerning read error rates experienced in the raw read data received in the signal RCW.

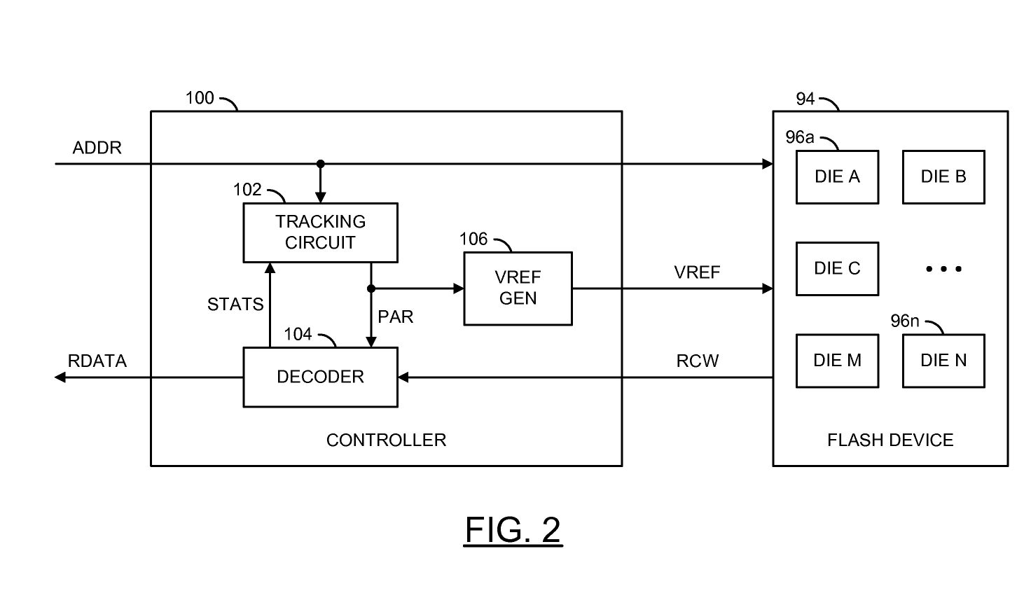

Referring to FIG. 2, a block diagram of an example implementation of the circuit 100 is shown in accordance with a preferred embodiment of the present invention. The circuit 100 generally comprises a block (or circuit) 102, a block (or circuit) 104 and a block (or circuit) 106. The circuit 94 may comprise multiple blocks (or circuits) 96a-96n. The circuits 96a to 106 may represent modules and/or blocks that may be implemented as hardware, software, a combination of hardware and software, or other implementations.

The signal ADDR may be received by the circuits 94 and 102. The signal VREF may be generated by the circuit 106. The signal RCW may be received by the circuit 104. The circuit 104 may generate the signal RDATA. A signal (e.g., STATS) may be generated by the circuit 104 and transferred to the circuit 102. The signal STATS may convey status information concerning a decode of the ECC codewords received in the signal RCW. The circuit 102 may generate a signal (e.g., PAR) that is received by the circuit 106, and optionally received by the circuit 104. The signal PAR may carry multiple parameters that characterize the read channel (e.g., flash channel) properties of the circuit 94.

Each circuit 96a-96n may implement a flash device. In some embodiments, each circuit 96a-96n may be fabricated as an individual die (or chip). Each circuit 96a-96n generally comprises multiple memory cells.

Each memory cell may store a single bit (in SLC type memory) or multiple bits (in MLC and TLC type memory). Multiple bits are generally grouped into pages, word lines, blocks or the like. In some embodiments, a single group may span an entire circuit 96a-96n. Due to noise, the actual threshold voltage of each memory cell may be different. Therefore, the threshold voltages of each group of memory cells generally form a distribution. Each distribution of the threshold voltages may be defined by the channel parameters (e.g., a mean threshold voltage μ and a standard deviation σ from the mean threshold voltage). The different channels may be treated independently of each other, depending on a tracking granularity. For example, different blocks in the same flash die (e.g., circuit 96a) may exhibit different channel parameters (e.g., different threshold voltage distributions).

The circuit 102 may implement a tracking circuit. The circuit 102 is generally operational to track and update the read channel (e.g., flash channel) parameters (or properties) in response to an error correction applied to a set of data read from the circuit 94. In some embodiments, the channel parameters may be tracked separately for each group of memory cells. For MLC and/or TLC type memories having four of more states per memory cell, the circuit 102 may also be configured to extrapolate the channel parameters corresponding to the outer states based on changes in the parameters corresponding to the middle two states. The channel parameters for the group containing the current set of memory cells being read may be presented in the signal PAR.

The circuit 104 may implement a decoder circuit. The circuit 104 is generally operational to decode (or error detect and correct) each set of data received in the signal RCW. The corrected data may be presented in the signal RDATA. The statistics may be gathered during the correction by the circuit 104. The statistics generally include, but are not limited to, a total number of zero data bits in the corrected set, a total number of one data bits in the corrected set, a total number of bits corrected from zero to one, and a total number of bits corrected from one to zero. The statistics may be presented in the signal STATS.

To fight noise, the data stored in the circuit 94 is usually error correction coded. Decoding is generally performed by the circuit 104 when reading the ECC data from the circuit 94. In some embodiments, ECC encoding is paired with hard-decision decoders, such as Bose, Ray-Chaudhuri and Hocquenghem (e.g., BCH) decoders and hard-decision Reed-Solomon decoders. In some embodiments, soft decision decoders, such as Viterbi decoders for convolutional codes and soft decoders for low density parity check (e.g., LDPC) codes may be implemented in the circuit 104.

The circuit 106 may be implemented as a reference voltage generator circuit. The circuit 106 is generally operational to generate a variable reference voltage used by the circuit 94 in reading a set of data from the circuit 94. The circuit 106 may also be operational to adjust the reference voltage based on one or more updated channel parameters received from the circuit 102 in the signal PAR. For example, the circuit 106 may adjust the reference voltage in the signal VREF higher or lower to track a shift in a mean threshold voltage of a group. Adjusting the reference voltage generally lowers an error rate in subsequent reads from the circuit 94.

Having a good knowledge of the channel parameters may be useful in lowering an overall read error rate. For example, knowledge of the channel parameters may help the circuit 100 pick a good reference voltage when reading from the circuit 94. Due to retention, the threshold voltage distributions may drift away from the original distributions. Without knowing the drifts, a fixed reference voltage may eventually lead to more read errors, which may exceed the error correction capability of the circuit 104 and therefore lead to read failures.

Knowledge of the channel parameters may also help the circuit 100 pick better decoding parameters. For example, in implementations of the circuit 104 that have an LDPC decoder with a log likelihood ratio (e.g., LLR) type of decoder input, the changes in threshold voltage distributions may result in changes to the LLR computation for the decoder. Without knowing the channel parameters, the LLR computation may becomes sub-optimal thus leading to poor decoding performance.

Measurements of the channel parameters for each group may be performed online and/or offline. The offline tracking generally utilizes additional reads exclusively intended for channel tracking purposes. The online channel tracking generally does not utilize the additional reads. For example, if the circuit 100 is issuing a read due to a read request from the circuit 92, such a read is generally not considered an additional read. If the circuit 100 is issuing a read for maintenance purposes, such as moving a partially written block, such reads are generally not considered additional reads. Because each flash read involves performance hits in latency/throughput/power, the online channel tracking may have a higher performance than the offline channel tracking.

The offline measurements may be a straightforward way of determining the threshold voltage distributions of each group. Directly measuring the threshold voltage distributions generally involves many reads on each group of memory cells, because the circuit 100 generally supports hard-decision reads. If the circuit 100 provides direct soft reads through an analog-to-digital converter (e.g., ADC), some channel tracking may be capable, although possibly limited due to the finite precision of the ADC. The online channel tracking generally is achieved with fewer reads than the offline tracking.

Referring to FIG. 3, a graph 120 of example SLC threshold voltage distributions is shown. If m bits are stored in a memory cell, the cell generally has 2^{m} levels of threshold voltages corresponding to 2^{m} possible states. Each state may be mapped to an m-bit symbol. For SLC types of memory cells, m=1. For MLC types of memory cells, m=2. For TLC types of memory cells, m=3, and so on. Due to various noises, the threshold voltage of each state may be a random variable (e.g., RV) rather than a fixed value. The distribution of the threshold voltages may be mathematically modeled in many possible ways. To make online tracking simple and feasible, the threshold voltages may be modeled as a random variable with a Gaussian distribution having a mean threshold voltage (e.g., μ) and a standard deviation (e.g., σ). Therefore, a probability distribution function for a state may be referred to as N(μ, σ²).

For an SLC type device, a further simplification may be made that the standard deviations of the two states are the same. Based on the simplification, the channel may be modeled as shown in FIG. 3. The two states “1” and “0” generally follow distributions N(μ1, σ²) and N(μ2, σ²), respectively. A “distance” (e.g., D) between the peaks of the two states may be defined as D=|μ1−μ2|.

A motivation for the online channel tracking may be to track the threshold voltage distribution parameters as the flash device deteriorates by utilizing normal reads issued for other purpose (e.g., host read). The normal reads may be considered hard-decision reads processed by the circuit 104. If the decoding is successful, the decoding statistics may be extracted to help track the channel parameters.

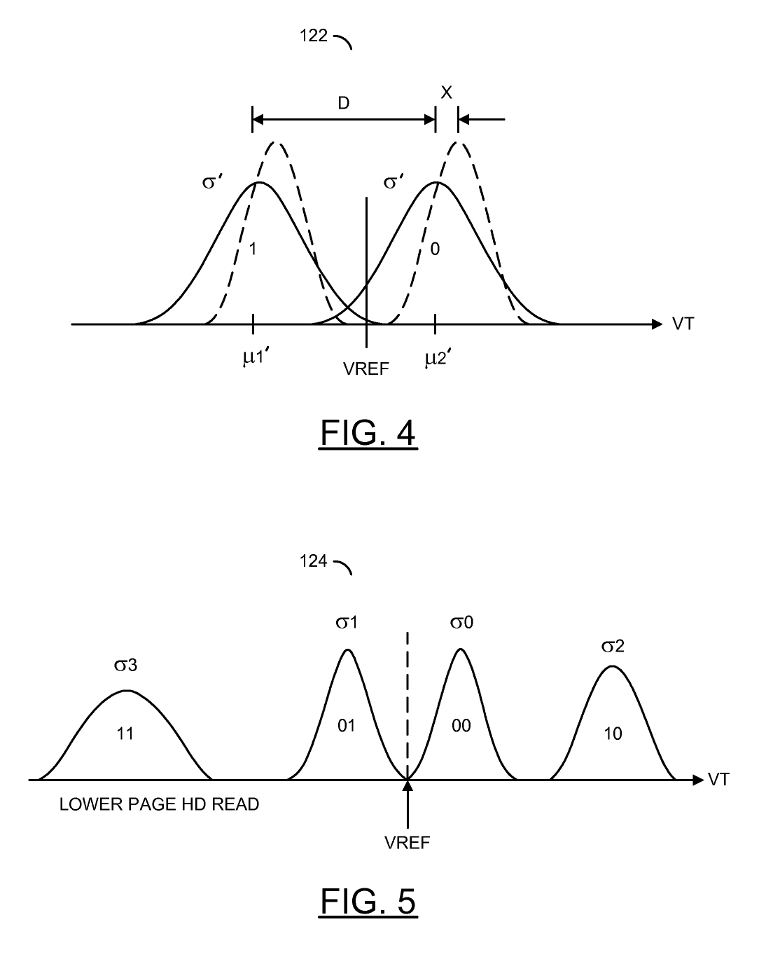

Referring to FIG. 4, a graph 122 of shifted SLC threshold voltage distributions is shown. Due to program/erase cycling, retention, program/read disturbance and such, the distributions of the threshold voltages for both states generally change over time. The model generally considers the threshold voltage distributions of the two states to change by similar amounts in both mean and standard deviation. For example, if the mean threshold voltages of both states drifts lower by an amount (e.g., X volts), and the standard deviations of both states become σ′, the channel model becomes what is shown in FIG. 4. The Gaussian distributions of the two states generally become N(μ1′, σ′²) and N(μ2′, σ′²), respectively, where μ1′=μ1−X, and μ2′=μ2−X. Note that the distance D between the two states may be modeled as unchanged from FIG. 3.

The model is generally a mathematical modeling of how the threshold voltage distributions change, and may not be limited to any single noise effects (e.g., retention effects, program/erase cycling effects or any other). Although the change in the threshold voltage distributions illustrated in FIG. 4 may be caused by retention, the model may be used for program/erase cycling or a combination of both retention and program/erase cycling. Furthermore, the online channel tracking may be orthogonal of other channel tracking techniques. For example, since the circuit 100 generally knows when a flash block is erased, the circuit 100 may have accurate knowledge of program/erase counts of each block and may incorporate other channel tracking methods suitable for program/erase cycle effects after each erase.

The reference voltage in the signal VREF used in normal reads is also plotted in FIG. 4. Without knowing that the channel has changed, circuit 100 may place the default reference voltage in the middle of the two states. The default reference voltage may be skewed for the true threshold voltage distributions of the two states.

If the changes in the channel parameters are not dramatic, the circuit 104 may still be able correct the normal hard-decision reads and send the corrected bits to circuit 92 or any other circuit that requested the read. In the meantime, the circuit 104 may determine how many one-to-zero errors and how many zero-to-one errors were corrected out of the total number of bits in the ECC codeword (or set). The decoder statistics may be utilized by the circuit 102 in adjusting the channel parameters. For example, the reference voltage may be adjusted by the value X.

Let a number of zero-to-one (e.g., 0-1) errors corrected by the circuit 104 be an error value (e.g., e₀₁) and a number of one-to-zero (e.g., 1→0) errors corrected be another error value (e.g., e₁₀). A true number of zeros (e.g., n₀) and ones (e.g., n₁) in the codeword may be considered as know values. Generally, the values e₀₁, e₁₀, n₀ and n₁ may be available once decoding converges. Using the Gaussian channel model, ratios of errors to total numbers of bits may be defined by equation set 1 as follows:

$$\{ \begin{matrix}Q ( \frac{Vref - {μ}_{1}^{′}}{{σ}^{′}} ) = Q ( \frac{Vref - {μ}_{1} + x}{{σ}^{′}} ) = \frac{{e}_{10}}{{n}_{1}} , \\ Q ( \frac{{μ}_{2}^{′} - Vref}{{σ}^{′}} ) = Q ( \frac{{μ}_{2} - x - Vref}{{σ}^{′}} ) = \frac{{e}_{01}}{{n}_{0}} ,\end{matrix} \qquad ( 1 )$$

where the Q-function may be defined by equation 2 as follows:

$$Q ( y ) = \frac{1}{\sqrt{2 π}} {\int }_{y}^{∞} exp ( - \frac{{u}^{2}}{2} ) d u . \qquad ( 2 )$$

If μ1 and μ2 are already known through previous online channel measurements and/or offline channel tracking, the two unknown parameters in equation set 1 may be X and σ′. The two unknowns may be found by solving the two equations in the equation set. A closed-form solution for the two unknown parameters may be given by equation set 3 as follows:

$$\{ \begin{matrix}{σ}^{′} = \frac{{μ}_{2} - {μ}_{1}}{{Q}^{- 1} ( \frac{{e}_{10}}{{n}_{1}} ) + {Q}^{- 1} ( \frac{{e}_{01}}{{n}_{0}} )} , \\ x = [ \frac{1}{2} ( {μ}_{1} + {μ}_{2} ) - Vref ] + ( {μ}_{2} - {μ}_{1} ) \cdot \frac{{Q}^{- 1} ( \frac{{e}_{10}}{{n}_{1}} ) - {Q}^{- 1} ( \frac{{e}_{10}}{{n}_{0}} )}{{Q}^{- 1} ( \frac{{e}_{10}}{{n}_{1}} ) + {Q}^{- 1} ( \frac{{e}_{01}}{{n}_{0}} )} .\end{matrix} \qquad ( 3 )$$

In practical systems, the inverse Q-function in equation set 3 may be implemented as a look-up table (e.g., LUT). Equation set 3 may be used for tracking the channel parameters online with the statistics X and σ′ presented in the signal STATS.

Simplifications and/or approximations of equation set 3 may be implemented in different embodiments to reduce the number of multiplications and/or divisions. For example, if σ′ is approximated as σ, where σ is known (e.g., from channel measurement or offline channel tracking), only X may be computed and the second line in equation set 3 may be simplified.

Based on the channel model, equation set and considering that the channel is not changing rapidly, other techniques may be used to find the roots of equation set 1. Newton's method may be applied to the two equations in equation set 1 to generate equation set 4 as follows:

$$\{ \begin{matrix}{σ}^{′} \approx σ + \frac{σ}{d} \cdot \frac{( \frac{{e}_{01}}{{n}_{0}} + \frac{{e}_{10}}{{n}_{1}} ) - 2 Q ( \frac{d}{σ} )}{\frac{1}{σ \sqrt{2 π}} \cdot exp ( - \frac{{d}^{2}}{8 {σ}^{2}} )} , \\ x \approx \frac{( \frac{{e}_{01}}{{n}_{0}} - \frac{{e}_{10}}{{n}_{1}} )}{\frac{2}{σ \sqrt{2 π}} \cdot exp ( - \frac{{d}^{2}}{8 {σ}^{2}} )} ,\end{matrix} \qquad ( 4 )$$

where D=|μ2−μ1| may be the distance between the threshold voltage means of the two states. Typically, Newton's method may be an iterative method of finding roots for equations. Here, if the initial values of σ and D are known and the channel changes slowly, a single iteration generally provides an approximation to update the channel parameters.

For memory cells that store more than one bit (such as MLC and TLC, etc.), equation sets 3 and 4 may not be directly applied to normal reads with more than a single reference voltage, (e.g., non-lower page reads). However, with the mean and standard deviation online tracking results from either equation sets 3 or 4, the changes of the two middle threshold voltage states may be extrapolated to the other states.

Referring to FIG. 5, a graph 124 of example MLC threshold voltage distributions is shown. In each MLC flash memory cell, multiple (e.g., four) states may be used to store multiple (e.g., two) bits per cell. Therefore, each set of MLC memory cells may have multiple (e.g., four) distributions. Gray mapping may be used to map the bits in adjacent states such that each pair of adjacent states differ by single bit. Online channel tracking may be applied to the lower page (e.g., the right of the two bits) hard-decision reads. In upper page (e.g., the left of the two bits) hard-decision reads, the directional errors (e.g., 0→1 and 1→0) may result from both crossovers: between “11” and “01” and between “00” and “10”. Therefore, the model in FIG. 3 may not be applicable. However, equation sets 3 and 4 may still be used for tracking the threshold voltage distributions of the states “01” and “00” by approximating σ₁=σ₀=σ and n₁₁=n₀₁=n₀₀=n₁₀=n and treating “11”→“00” and “10“→”01” errors as negligible.

Once the updated standard deviations and means for the states “01” and “00” have been calculated, the updated means and standard deviations for states “11” and “00” may be calculated through extrapolation based on the channel characteristics. For example, using the online channel tracking to track retention effects, the retention noise may be modeled as an additive Gaussian noise N(−xₛ,Δσₛ²),sε{11, 01, 00, 10} for each state. Therefore, the retention noise for each state may be modeled per equation set 5 as follows:

$$\{ \begin{matrix}{x}_{s} = K ( {μ}_{s} - {c}_{0} ) {K}_{d} {N}^{0.5} ln ( 1 + \frac{t}{{t}_{0}} ) \\ {Δσ}_{s}^{2} = K ( {μ}_{s} - {c}_{0} ) {K}_{m} {N}^{0.6} ln ( 1 + \frac{t}{{t}_{0}} ) ,\end{matrix} \\ s = 11 , 01 , 00 , 10 , \qquad ( 5 )$$

where K, K_{d}, Kₘ, c₀ and t₀ may be constants, N may be the program/erase cycle count and t may be a retention time, which are the same for memory cells in the same word line. Based on equation set 5, once the changes of μ and σ for state “01” and “00” are known, the threshold voltage distribution changes for states “11” and “10” may also be estimated. Without loss of generality, the change in the threshold voltage distribution for the state “10” (modeled by the mean drift X₁₀ and a new standard deviation σ′₁₀) may be estimated by equation set 6 as follows:

$$\{ \begin{matrix}{x}_{10} = {x}_{00} \cdot \frac{{μ}_{10} - {c}_{0}}{{μ}_{00} - {c}_{0}} , \\ {σ}_{10}^{′} = {σ}_{10} + [ {( ( σ ) ]}_{00}^{′} - {σ}_{00} ) \cdot {( \frac{{μ}_{10} - {c}_{0}}{{μ}_{00} - {c}_{0}} )}^{0.5} .\end{matrix} \qquad ( 6 )$$

The online channel tracking method may be applied in the circuit 100 for solid state drives, embedded storage, and similar memory systems. When the circuit 104 successfully decodes a hard-decision set of read data, the corresponding statistics may be generated and transferred to the circuit 102. The circuit 102 generally updates the channel parameters and presents the updated parameters in the signal PAR.

A different set of channel parameters may be maintained for each group within the circuit 94. For example, the circuit 100 may keep a set of channel parameters for each circuit (or die) 96a-96n within the circuit 94. When the circuit 92 requests a read from a particular circuit 96a-96n (e.g., 96b), the circuit 104 may decode the hard-decision read, return the requested data in the signal RDATA and present the statistics in the signal STATS. Based on the decoder statistics, the circuit 102 generally updates the channel parameters for the particular circuit 96b, while the channel parameters of the other circuits 96a and 96c-96n remain unchanged.

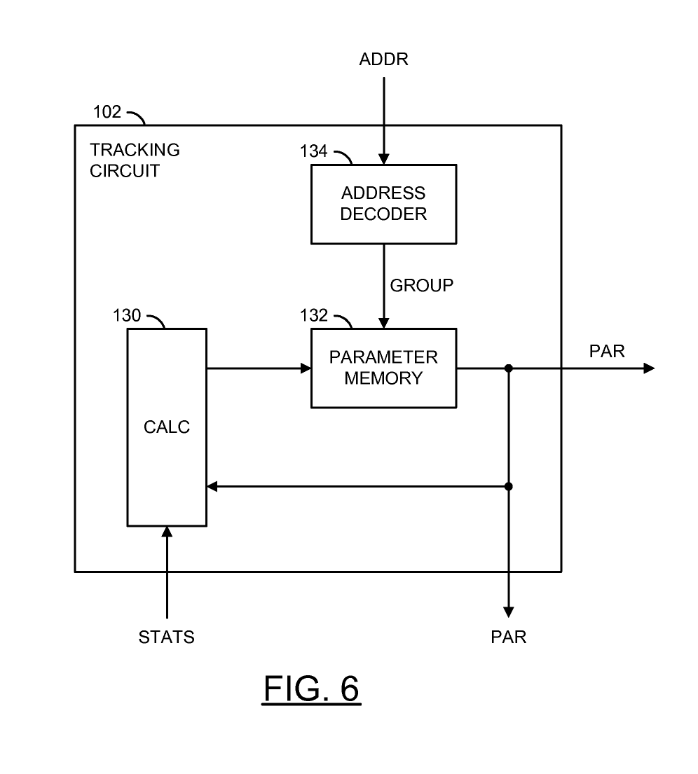

Referring to FIG. 6, a block diagram of an example implementation of the circuit 102 is shown. The circuit 102 generally comprises a block (or circuit) 130, a block (or circuit) 132 and a block (or circuit) 134. The circuits 130 to 134 may represent modules and/or blocks that may be implemented as hardware, software, a combination of hardware and software, or other implementations.

The signal ADDR may be received by the circuit 134. The signal STATS may be received by the circuit 130. The signal PAR may be generated by the circuit 132 and received by the circuit 130. A signal (e.g., GROUP) may be generated by the circuit 134 and received by the circuit 132. The signal GROUP may identify which particular group in the circuit 94 is being accessed.

The circuit 130 may implement a calculation circuit. The circuit 130 is generally operational to update the channel parameters based on the statistics received in the signal STATS and the current channel parameters received in the signal PAR. The updated channel parameters may be transferred to the circuit 132.

The circuit 132 may implement a parameter memory circuit. The circuit 132 is generally operational to store the channel parameters for each group. The current parameters for the current group (identified in the signal GROUP) may be read and presented in the signal PAR. Updated parameters for the current group received from the circuit 130 may be stored. In some embodiments, the channel parameters may be copied from time to time to the circuit 94 for nonvolatile storage while power is removed. When power is returned, the channel parameters may be copied from the circuit 94 back to the circuit 132.

The circuit 134 may implement and address decoder circuit. The circuit 134 is generally operational to decode the address value received in the signal ADDR into a particular group within the circuit 94. A decoded group value (or identification) may be transferred to the circuit 132 in the signal GROUP.

The memory cells in the circuit 94 may stores a single bit per cell (e.g., SLC) or multiple bits per cell (e.g., MLC or TLC). The threshold voltage distributions in an SLC type memory may be modeled as shown in FIG. 3. The mean threshold voltages and standard deviations of the two states in the SLC case may be updated using equation set 4. Both σ′ and X may be treated as linear functions of

$$\frac{{e}_{01}}{{n}_{0}}$$

$$and$$

$$\frac{{e}_{10}}{{n}_{1}} .$$

Therefore, given that the circuit 100 already knows the original channel parameters (e.g., μ1, μ2 and σ), the coefficients in equation set 4 may be pre-computed by the circuit 102, and the online channel tracking method is generally defined by equation set 7 as follows:

$$\{ \begin{matrix}{σ}^{′} \approx σ + A \cdot ( \frac{{e}_{01}}{{n}_{0}} + \frac{{e}_{10}}{{n}_{1}} - B ) , \\ x \approx C \cdot ( \frac{{e}_{01}}{{n}_{0}} - \frac{{e}_{10}}{{n}_{1}} ) ,\end{matrix} \qquad ( 7 )$$

where A, B, C may be coefficients pre-computed based on equation set 4.

In the MLC case, while decoding a lower page codeword the circuit 104 may not be able to exactly count the number of cells in the state “01” and cells in the state “00”. If a good (or complete) randomization is used with equation set 3, the number of cells in each state may be considered to be the same (e.g., n). Therefore, the channel parameters may be updated by equation set 8 as follows:

$$\{ \begin{matrix}{σ}^{′} = \frac{{μ}_{00} - {μ}_{01}}{{Q}^{- 1} ( \frac{{e}_{10}}{n} ) + {Q}^{- 1} ( \frac{{e}_{01}}{n} )} , \\ x = [ \frac{1}{2} ( {μ}_{01} + {μ}_{00} ) - Vref ] + ( {μ}_{00} - {μ}_{01} ) \cdot \frac{{Q}^{- 1} ( \frac{{e}_{10}}{n} ) - {Q}^{- 1} ( \frac{{e}_{01}}{n} )}{{Q}^{- 1} ( \frac{{e}_{10}}{n} ) + {Q}^{- 1} ( \frac{{e}_{01}}{n} )} .\end{matrix} \qquad ( 8 )$$

Although the states “11” and “10” may not be directly tracked, the extrapolation method described in equation set 6 may be applied to estimate the channel parameters for the states “11” and “10”. For example, using equation set 6, an estimate of the drift for state “10” may be X₁₀=αX, where

$$α = \frac{{μ}_{10} - {c}_{0}}{{μ}_{00} - {c}_{0}} .$$

A good (or complete) randomization used with equation set 4 may also be applied to MLC devices and TLC devices. In particular, equation set 7 may be used, where n₀=n₁=n. After the channel parameters for states “01” and “00” are estimated, equation set 6 may be used to track the channel parameters for the other two states.

The functions performed by the diagrams of FIGS. 1, 2 and 6 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to the preferred embodiments thereof, it will be understood by those skilled in the art that various changes in form and details may be made without departing from the scope of the invention.

1. An apparatus comprising:
a first circuit configured to (i) generate a reference voltage used by a memory circuit in a first read of a set of data and (ii) adjust said reference voltage based on a plurality of parameters to lower an error rate in a second read of said set from said memory circuit; and
a second circuit configured to update said parameters in response to an error correction applied to said set after said first read from said memory circuit, wherein said memory circuit is configured to store said data in a nonvolatile condition by adjusting a plurality of threshold voltages.

2. The apparatus according to claim 1, wherein (i) said memory circuit comprises a flash memory and (ii) said parameters corresponding to said set track (a) a drift of a mean voltage among said threshold voltages in said set and (b) a spread of said threshold voltages about said mean voltage in said set.

3. The apparatus according to claim 1, further comprising a third circuit configured to generate a plurality of statistics as part of said error correction of said set, wherein said second circuit updates said parameters based on said statistics.

4. The apparatus according to claim 1, wherein said set is read in response to a read request received from a host.

5. The apparatus according to claim 1, wherein (i) an address space of said memory circuit comprises a plurality of groups, (ii) each of said groups comprises one of (a) a die, (b) a block, (c) a word line and (d) a page and (iii) said set is stored within one of said groups.

6. The apparatus according to claim 5, wherein said parameters corresponding to each of said groups are updated separately.

7. The apparatus according to claim 1, wherein (i) said memory circuit comprises a plurality of cells and (ii) each of said cells stores a plurality of bits in four or more states.

8. The apparatus according to claim 7, wherein said second circuit is further configured to extrapolate said parameters corresponding two or more of said states based on changes in said parameters corresponding a middle two of said states.

9. The apparatus according to claim 1, further comprising a third circuit configured to (i) perform said error correction and (ii) adjust said error correction using said parameters.

10. The apparatus according to claim 1, wherein said apparatus is implemented as one or more integrated circuits.

11. A method for memory read error rate reduction, comprising the steps of:
(A) generating a reference voltage used by a memory circuit in a first read of a set of data, wherein said memory circuit is configured to store said data in a nonvolatile condition by adjusting a plurality of threshold voltages;
(B) updating a plurality of parameters in response to an error correction applied to said set after said first read from said memory circuit; and
(C) adjusting said reference voltage based on said parameters to lower an error rate in a second read of said set from said memory circuit.

12. The method according to claim 11, wherein (i) said memory circuit comprises a flash memory and (ii) said parameters corresponding to said set track (a) a drift of a mean voltage among said threshold voltages in said set and (b) a spread of said threshold voltages about said mean voltage in said set.

13. The method according to claim 11, further comprising the step of:
generating a plurality of statistics as part of said error correction of said set, wherein said parameters are updated based on said statistics.

14. The method according to claim 11, wherein said set is read in response to a read request received from a host.

15. The method according to claim 11, wherein (i) an address space of said memory circuit comprises a plurality of groups, (ii) each of said groups comprises one of (a) a die, (b) a block, (c) a word line and (d) a page and (iii) said set is stored within one of said groups.

16. The method according to claim 15, wherein said parameters corresponding to each of said groups are updated separately.

17. The method according to claim 11, wherein (i) said memory circuit comprises a plurality of cells and (ii) each of said cells stores a plurality of bits in four or more states.

18. The method according to claim 17, further comprising the step of:
extrapolating said parameters corresponding two or more of said states based on changes in said parameters corresponding a middle two of said states.

19. The method according to claim 11, further comprising the step of:
adjusting said error correction using said parameters.

20. An apparatus comprising:
means for generating a reference voltage used by a memory circuit in a first read of a set of data, wherein said memory circuit is configured to store said data in a nonvolatile condition by adjusting a plurality of threshold voltages;
means for updating a plurality of parameters in response to an error correction applied to said set after said first read from said memory circuit; and
means for adjusting said reference voltage based on said parameters to lower an error rate in a second read of said set from said memory circuit.
